(19) United States
(12) Patent Application Publication
(10) Pub. No.: US 2026/0188311 A1
(43) Pub. Date: Jul. 2, 2026

(54) OPERATION METHOD OF INFORMATION PROCESSING DEVICE, AND INFORMATION PROCESSING DEVICE

(71) Applicant: TOYOTA JIDOSHA KABUSHIKI KAISHA, Toyota-shi (JP)

(72) Inventor: Yuma ISHINO, Tokyo (JP)

(73) Assignee: TOYOTA JIDOSHA KABUSHIKI KAISHA, Toyota-shi (JP)

(21) Appl. No.: 19/419,739

(22) Filed: Dec. 15, 2025

(30) Foreign Application Priority Data
Dec. 26, 2024 (JP) 2024-231178

(51) Int. Cl. G10L 15/183; G06F 16/34; G10L 15/26

(52) U.S. Cl. CPC G10L 15/183; G06F 16/345; G10L 15/26

(57) ABSTRACT

An information processing device includes a control unit. The control unit is configured to, based on voice data of a conversation between a salesperson and a customer, each time a first topic that is a current topic of the conversation changes, present a summary relating to a third topic that is a past topic.

### CROSS-REFERENCE TO RELATED APPLICATION

This application claims priority to Japanese Patent Application No. 2024-231178 filed on December 26, 2024. The disclosure of the above-identified application, including the specification, drawings, and claims, is incorporated by reference herein in its entirety.

### BACKGROUND

### 1. TECHNICAL FIELD

The present disclosure relates to an operation method of an information processing device and to an information processing device.

### 2. Description of Related Art

There is a known technology that summarizes the contents of a conversation from voice data of the conversation. For example, Japanese Unexamined Patent Application Publication No. 2019-28910 (JP 2019-28910 A) discloses a conversation analysis system that records conversation data based on voice data recorded of a conversation, extracts contents of the conversation that match conditions specified by a user from the conversation data and shows the extracted contents as a list.

### SUMMARY

As machine learning and other techniques develop, technologies of summarizing the contents of a conversation from voice data of the conversation leave room for improvement in terms of the accuracy of summarization.

The present disclosure improves the accuracy of summarization of the contents of a conversation based on voice data of the conversation.

An operation method of an information processing device according to one embodiment of the present disclosure includes:

acquiring voice data of a conversation between a salesperson and a customer;

using a voice recognition technology, converting the voice data into text data;

using co-occurrence analysis or a topic model, deriving a first topic that is a current topic of the conversation from the text data; and

each time a change of the first topic is detected,

identifying voice data of a conversation part relating to a second topic that is an immediately preceding topic;

generating a summary of the conversation part based on the identified voice data; and

presenting the generated summary to the salesperson.

An operation method of an information processing device according to one embodiment of the present disclosure includes, based on voice data of a conversation between a salesperson and a customer, each time a first topic that is a current topic of the conversation changes, presenting a summary relating to a third topic that is a past topic.

The operation method of an information processing device may further include, when the first topic corresponds to one of a plurality of preset important topics, presenting the salesperson with important topics other than the important topic corresponding to the first topic.

The operation method of an information processing device may further include, when the first topic corresponds to a preset important topic, presenting the salesperson with a keyword that has been associated beforehand with the important topic corresponding to the first topic and that is not included in the conversation.

The operation method of an information processing device may further include, each time the first topic changes, deriving and storing emotional states of the salesperson and the customer based on voice data of a conversation part relating to the third topic.

In the operation method of an information processing device, the information processing device (20) may be configured to derive and store the emotional states of the salesperson and the customer based further on image data of the conversation.

The operation method of an information processing device may further include presenting the salesperson with a topic that is supposed to be taken up next based on the summary.

The operation method of an information processing device may further include, when the first topic corresponds to a preset trend topic, presenting the salesperson with a past summary or a response manual relating to the trend topic.

The operation method of an information processing device may further include, when the first topic has not changed for a predetermined time or longer, determining that the first topic has changed.

An information processing device according to one embodiment of the present disclosure includes a control unit configured to:

acquire voice data of a conversation between a salesperson and a customer; using a voice recognition technology, convert the voice data into text data; using co-occurrence analysis or a topic model, derive a first topic that is a current topic of the conversation from the text data; and each time a change of the first topic is detected, identify voice data of a conversation part relating to a second topic that is an immediately preceding topic; generate a summary of the conversation part based on the identified voice data; and present the generated summary to the salesperson.

An information processing device according to one embodiment of the present disclosure includes a control unit configured to, based on voice data of a conversation between a salesperson and a customer, each time a first topic that is a current topic of the conversation changes, present a summary relating to a third topic that is a past topic.

In the information processing device, the control unit may be configured to, when the first topic corresponds to one of a plurality of preset important topics, present the salesperson with important topics other than the important topic corresponding to the first topic.

In the information processing device, the control unit may be configured to present the salesperson with important topics that do not correspond to the third topic among a plurality of preset important topics.

In the information processing device, the control unit may be configured to, when the first topic corresponds to a preset important topic, present the salesperson with a keyword that has been associated beforehand with the important topic corresponding to the first topic and that is not included in the conversation.

In the information processing device, the control unit may be configured to, each time the first topic changes, derive and store emotional states of the salesperson and the customer based on voice data of a conversation part relating to the third topic.

In the information processing device, the control unit may be configured to derive and store the emotional states of the salesperson and the customer based further on image data of the conversation.

In the information processing device, the control unit may be configured to present the salesperson with a topic that is supposed to be taken up next based on the summary.

In the information processing device, the control unit may be configured to, when the first topic corresponds to a preset trend topic, present the salesperson with a past summary or a response manual relating to the trend topic.

In the information processing device, the control unit may be configured to, when the first topic has not changed for a predetermined time or longer, determine that the first topic has changed.

One embodiment of the present disclosure can improve the accuracy of summarization of the contents of a conversation based on voice data of the conversation.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a simplified configuration of a system according to one embodiment of the present disclosure;

FIG. 2 is a block diagram showing a simplified configuration of a terminal device;

FIG. 3 is a block diagram showing a simplified configuration of an information processing device; and

FIG. 4 is a flowchart showing the operation of the information processing device.

### DETAILED DESCRIPTION OF EMBODIMENTS

In the following, an embodiment of the present disclosure will be described.

### Overview of Embodiment

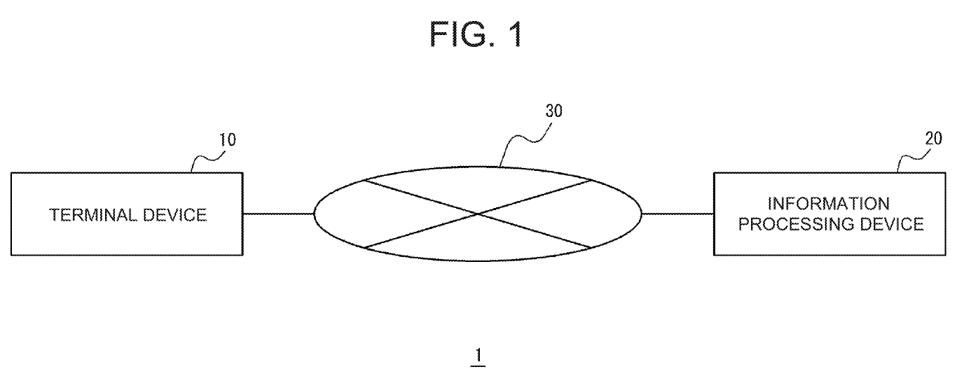

An overview of an information processing system 1 according to an embodiment of the present disclosure will be described with reference to FIG. 1. The information processing system 1 includes one or more terminal devices 10 and one or more information processing devices 20. The terminal device 10 and the information processing device 20 are communicably connected to a network 30, of which examples include the Internet and a mobile communication network.

The terminal device 10 is a computer, for example, a personal computer (PC), a smartphone, or a tablet terminal. The terminal device 10 is a computer that a salesperson at a shop, for example, a car dealership, uses in conversations with customers.

The information processing device 20 is, for example, one server computer or more server computers that are communicable with one another. The information processing device 20 can perform information communication with each terminal device 10 through the network 30. The information processing device 20 provides a service that salespersons at a shop, for example, a car dealership, use.

In this embodiment, based on voice data of a conversation between a salesperson and a customer, each time a first topic that is a current topic of the conversation (hereinafter referred to as "current topic") changes, the information processing device 20 presents a summary relating to a third topic that is a past topic (hereinafter referred to as "past topic"). In this embodiment, a topic is a label attached in association with a word that appears frequently in a conversation. A label attached in association with a word may be selected from preset candidates. For example, candidates of labels for when the conversation between the salesperson and the customer is a business negotiation relating to a sale of a vehicle include "description of vehicle model," "insurance," "options of services added to vehicle," "payment method," and "description of legal matters." To a group of words representing the names of vehicles, such as "Crown" and "Lexus," the label "description of vehicle model" is attached, and to a group of words such as "lump-sum purchase" and "installment purchase," the label "payment method" is attached. The preset candidates of labels may include a label "others" that is attached to words that correspond to none of the candidates.

When summarizing the contents of a conversation from voice data of the conversation, inconvenience may arise if the recorded sound data is summarized in segments each of a predetermined duration time, or summarized in segments each corresponding to a predetermined number of letters reached by a transcription text of the recorded sound data. For example, in a relatively lengthy conversation like a business negotiation, it may be difficult to obtain a high-accuracy summary of the conversation as a whole if the conversation is summarized in short segments. In this embodiment, by contrast, each time a current topic of a conversation changes, a summary relating to a past topic is presented, so that even in the case of a relatively lengthy conversation like a business negotiation, for example, a summary is generated for each topic in the business negotiation as a unit. This can improve the accuracy of summarization compared with when a summary is generated based on a duration time of recorded sound data or an amount of text as a unit.

Next, each component of the information processing system 1 will be described.

### Configuration of Terminal Device

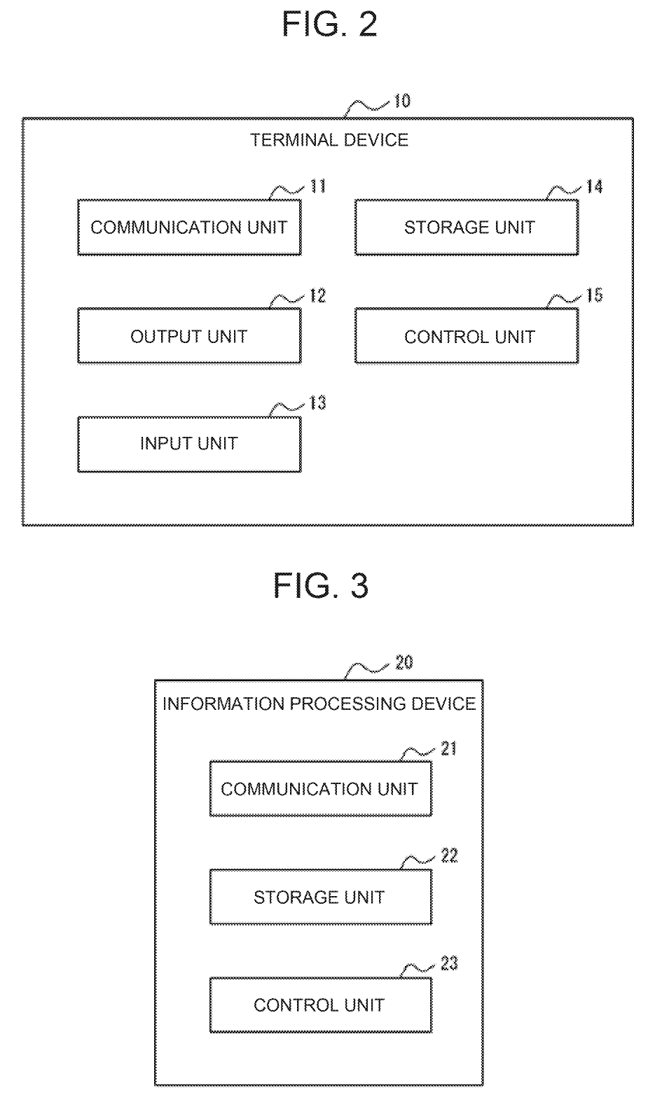

As shown in FIG. 2, the terminal device 10 includes a communication unit 11, an output unit 12, an input unit 13, a storage unit 14, and a control unit 15.

The communication unit 11 includes one or more communication interfaces that are connected to the network 30. The communication interface complies with a mobile communications standard, examples of which include, but are not limited to, 4th Generation (4G) and 5th Generation (5G). The terminal device 10 communicates with the information processing device 20 through the communication unit 11 and the network 30.

The output unit 12 includes one or more output devices that output information. The output device includes, for example, a display that outputs images and a speaker that outputs voices. Alternatively, the output unit 12 may include an interface for connecting an external output device.

The input unit 13 includes one or more input devices that detect an input operation performed by a user. The input device includes, for example, a physical key, a capacitive key, a mouse, a touch panel, a touch screen integrally provided in a display of the output unit 12, a microphone, etc. Alternatively, the input unit 13 may include an interface for connecting an external input device.

The storage unit 14 includes one or more memories. Examples of memories include, but are not limited to, a semiconductor memory, a magnetic memory, and an optical memory. Each memory included in the storage unit 14 may function as, for example, a main storage device, an auxiliary storage device, or a cache memory. The storage unit 14 stores arbitrary information used for the operation of the terminal device 10. For example, the storage unit 14 may store a system program, an application program, built-in software, etc. For example, the information stored in the storage unit 14 may be updatable with, for example, information acquired from the network 30 through the communication unit 11. The storage unit 14 may store the preset candidates of labels.

The control unit 15 includes one or more processors, one or more programmable circuits, one or more dedicated circuits, or a combination of these. Examples of processors include, but are not limited to, general-purpose processors, such as a central processing unit (CPU) and a graphics processing unit (GPU), and special-purpose processors specialized for specific processing. Examples of programmable circuits include, but are not limited to, a field-programmable gate array (FPGA). Examples of dedicated circuits include, but are not limited to, an application-specific integrated circuit (ASIC). The control unit 15 controls the operation of the terminal device 10.

### Configuration of Information Processing Device

As shown in FIG. 3, the information processing device 20 includes a communication unit 21, a storage unit 22, and a control unit 23.

The communication unit 21 includes one or more communication interfaces that are connected to the network 30. The communication interface complies with, for example, a mobile communications standard, a wired local area network (LAN) standard, or a wireless LAN standard, but is not limited to these and may comply with an arbitrary communications standard. The information processing device 20 communicates with each of the terminal devices 10 through the communication unit 21 and the network 30.

The storage unit 22 includes one or more memories. Each memory included in the storage unit 22 may function as, for example, a main storage device, an auxiliary storage device, or a cache memory. The storage unit 22 stores arbitrary information that is used for the operation of the information processing device 20. For example, the storage unit 22 may store a system program, an application program, built-in software, map information, etc. The storage unit 22 may store the preset candidates of labels.

The control unit 23 includes one or more processors, one or more programmable circuits, one or more dedicated circuits, or a combination of these. Examples of processors include, but are not limited to, general-purpose processors, such as a central processing unit (CPU) and a graphics processing unit (GPU), and special-purpose processors specialized for specific processing. Examples of programmable circuits include, but are not limited to, a field-programmable gate array (FPGA). Examples of dedicated circuits include, but are not limited to, an application-specific integrated circuit (ASIC). The control unit 23 controls the operation of the entire information processing device 20.

### Operation Flow of Information Processing Device

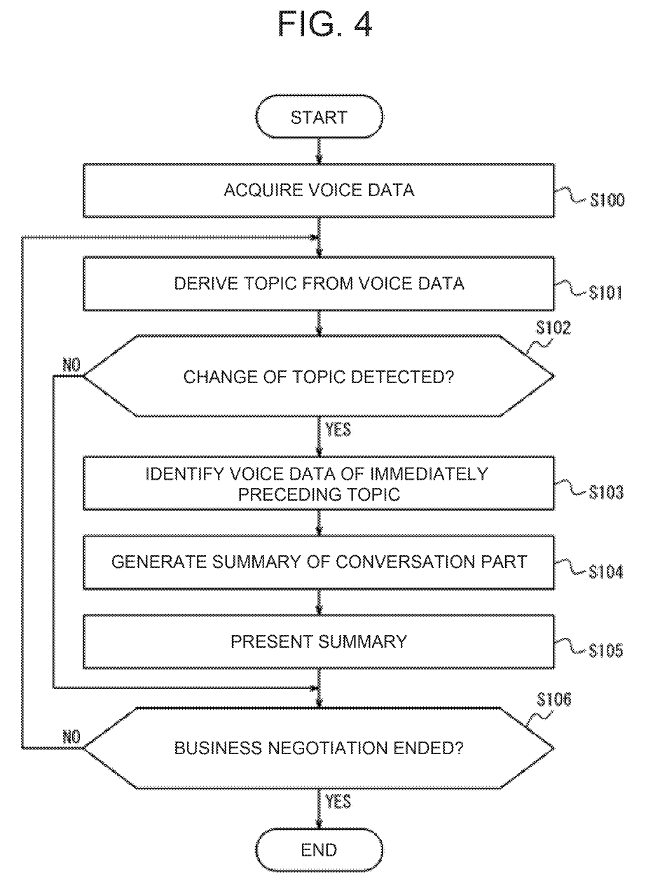

The operation of the information processing device 20 according to this embodiment will be described with reference to FIG. 4. Each step of FIG. 4 is a step of information processing that is executed by the control unit 23 of the information processing device 20. The procedure of FIG. 4 is executed by the control unit 23 at arbitrary intervals, for example, 10-millisecond intervals. The intervals at which the steps are executed can vary depending on the performance of the devices composing the information processing system 1, for example, the performance of the information processing device 20.

S100: The control unit 23 of the information processing device 20 acquires voice data of a conversation between a salesperson and a customer. Specifically, the control unit 23 receives voice data from the terminal device 10 through the network 30 by the communication unit 21. Using the microphone of the input unit 13 or a microphone that is connected through the input unit 13, the terminal device 10 acquires voice data of the salesperson and the customer conducting a business negotiation. Or the control unit 23 may receive the voice data directly from the microphone through the network 30 by the communication unit 21. The voice data is acquired at arbitrary intervals, for example, 10-millisecond intervals. The intervals at which the voice data is acquired can vary depending on the performance of the devices composing the information processing system 1, for example, the performance of the information processing device 20.

S101: The control unit 23 derives a current topic of the conversation from the voice data. Specifically, the control unit 23 converts the voice data into text data by a voice recognition technology. Examples of voice recognition technologies include arbitrary technologies such as natural language processing (NLP), hidden Markov model (HMM), and deep neural network (DNN). Then, the control unit 23 identifies a group of words that appear frequently in temporally close succession in the text data, and determines, as the current topic, one of the labels attached beforehand to the respective words. For example, when the name of a vehicle such as "Crown" or "Lexus" appears frequently in the text data, the control unit 23 determines, as the current topic, "description of vehicle model" that has been attached beforehand to "Crown," "Lexus," etc. as a label. When the word "lump-sum purchase" or "installment purchase" appears frequently in the text data, the control unit 23 determines, as the current topic, "payment method" that has been attached beforehand to "lump-sum purchase" and "installment purchase" as a label. When words with different labels attached thereto appear frequently, for example, the control unit 23 totals the frequencies of appearance, for example, the numbers of times of appearance, of words for each label, and determines, as the current topic, the label of words with the highest frequency of appearance. Alternatively, the control unit 23 may determine the current topic corresponding to a word that appears frequently in the text data by using a topic model. As the topic model, supervised latent Dirichlet allocation (sLDA) and other techniques can be adopted. Alternatively, the control unit 23 may make a large language model (LLM) identify a word that appears frequently in the text data and select a current topic corresponding to the frequently appearing word from the candidates of labels. The control unit 23 may use, for example, an LLM that is provided by an arbitrary operator on the cloud, or may use an LLM that is stored in the storage unit 22 of the information processing device 20.

S102: The control unit 23 detects a change of the current topic. Specifically, the control unit 23 compares the current topic that has been extracted in S101 of the current processing cycle and a current topic that has been extracted in S101 of a past, for example, the immediately preceding, processing cycle. When, as a result of the comparison, these current topics are different from each other (S102: Yes), the control unit 23 proceeds to S103, and when these current topics are determined to match (S102: No), the control unit 23 proceeds to S106.

S103: The control unit 23 identifies voice data corresponding to a past topic that has been a past, for example, the immediately preceding, current topic. Specifically, the control unit 23 identifies, as the voice data of the past topic, voice data from a start position of the conversation, or a position at which the last change but one of the current topic has been detected to a position at which the latest change of the current topic has been detected.

S104: Based on the identified voice data, the control unit 23 generates a summary of a conversation corresponding to the past topic. Specifically, the control unit 23 extracts a part corresponding to the voice data of the past topic identified in S103 from the text data generated in S101 of the past processing cycle. Next, using the extracted text data as input data, the control unit 23 generates a summary by means of, for example, an LLM. The control unit 23 may generate a summary by means of extractive summarization, generative summarization, or an arbitrary combination of these. The control unit 23 may use, for example, an LLM that is provided by an arbitrary operator on the cloud, or may use an LLM that is stored in the storage unit 22 of the information processing device 20.

S105: The control unit 23 presents the generated summary. Specifically, the control unit 23 transmits information on the summary generated in S104 to the terminal device 10 through the network 30 by the communication unit 21. Then, the control unit 15 of the terminal device 10 receives the information on the summary through the communication unit 11 and shows a screen including the summary on the display of the output unit 12 to thereby present the summary to the salesperson or the customer.

The control unit 23 may present an aggregate of summaries relating to an aggregate of past topics including a plurality of past topics. Specifically, when the number of times that a change of the current topic has been detected in S102 is two or larger, the control unit 23 transmits information not only on the summary generated in S104 of the current processing cycle but also on a summary or summaries generated in S104 of the previous processing cycle or cycles. Then, the control unit 15 of the terminal device 10 shows, on the display of the output unit 12, a screen showing the aggregate of summaries received through the communication unit 11, and thereby presents the salesperson with the aggregate of summaries relating to the aggregate of past topics. Alternatively, the control unit 15 may accumulate pieces of information on summaries received from the information processing device 20 in the storage unit 14, and show a screen showing the accumulated summaries on the display of the output unit 12 to thereby present the salesperson with the aggregate of summaries relating to the aggregate of past topics. The aggregate of summaries relating to the aggregate of past topics to be presented to the salesperson may be selectable by the salesperson. Specifically, the control unit 15 of the terminal device 10 may show, on the display, a screen in which the aggregate of summaries accumulated in the storage unit 14 are selectable in the form of a list, and when a summary is selected by the salesperson, the control unit 15 may show a screen showing the selected summary on the display.

S106: The control unit 23 determines whether the conversation between the salesperson and the customer has ended. For example, when the voice data has not been received from the terminal device 10 or a microphone installed in the shop for a predetermined time or longer, the control unit 23 may determine that the conversation has ended. The predetermined time is arbitrarily set, for example, within a range of 60 seconds to 300 seconds. Alternatively, when there is a possibility that a conversation with a customer like a business negotiation, for example, may be conducted in multiple separate times, the control unit 23 may determine that the conversation has ended upon receiving information relating to the conversation having ended from the terminal device 10. Specifically, for example, the control unit 15 of the terminal device 10 shows a screen relating to a conversation on the display. The control unit 15 transmits the information relating to the conversation having ended to the information processing device 20 when, for example, a button relating to end of a conversation provided in the screen is pressed by the salesperson. Upon receiving the information relating to the conversation having ended from the terminal device 10, the control unit 23 determines that the conversation has ended. When it is determined that the conversation has ended, the control unit 23 ends the processing process. Otherwise, the control unit 23 returns to S100. The method of determining whether the conversation has ended is not limited to the above-described one. For example, it may be determined that the conversation has ended when the control unit 23 detects, from the conversation between the salesperson and the customer, a word, a phrase, etc. based on which the conversation is deemed to have ended.

As has been described above, based on voice data of a conversation between a salesperson and a customer, each time a current topic of the conversation changes, the information processing device 20 presents a summary of a past topic.

In this configuration, each time a current topic of a conversation changes, a summary of a past topic is presented. Therefore, even in the case of a relatively lengthy

conversation like a business negotiation, for example, a summary for each topic in the business negotiation as a unit is generated, which can improve the accuracy of summarization compared with a conventional technique such as summarizing recorded sound data in segments each of a predetermined duration time. Thus, this embodiment can improve the accuracy of summarization compared with the conventional technique.

While the present disclosure has been described based on the drawings and examples of implementation, it should be noted that any person skilled in the art may make various changes and modifications based on the present disclosure. It should therefore be understood that such changes and modifications are included in the scope of the present disclosure. For example, functions etc. included in the constituent parts or the steps can be reallocated so as not to cause logical inconsistency, and a plurality of constituent parts, steps, etc. may be divided or combined into one.

For example, an embodiment is also possible in which the configuration and the operation of the information processing device 20 in the above-described embodiment are dispersed among a plurality of computers capable of communicating with one another. As another example, an embodiment is also possible in which some or all of the constituent elements of the information processing device 20 are provided in the terminal device 10. For example, the terminal device 10 may include some or all of the constituent elements of the information processing device 20.

For example, in the above-described embodiment, when the current topic corresponds to one of a plurality of arbitrarily preset important topics, the control unit 23 may present the salesperson with the other important topics (hereinafter referred to as "non-corresponding topics") than the important topic corresponding to the current topic (hereinafter referred to as "corresponding topic"). Important topics are those candidates among the candidates of labels of which the necessity of being taken up is high, and are arbitrarily preset. For example, when the conversation between the salesperson and the customer is a business negotiation relating to a sale of a vehicle, "description of vehicle model," "vehicle insurance," "options of services added to vehicle," "payment method," and "description of legal matters" are set as important topics, and each of the labels set as important topics is provided with information indicating an order in which it is supposed to be taken up. For example, for "description of vehicle model," "vehicle insurance," and "options of services added to vehicle" among the important topics, the order is specified in

the following sequence: "description of vehicle model," "options of services added to vehicle," and "vehicle insurance." When the control unit 23 has extracted a current topic in S101, the control unit 23 determines whether the current topic corresponds to an important topic. Determination as to whether the current topic corresponds to an important topic may be based on the condition of whether the current topic appears in accordance with the sequence set for the important topics. For example, the control unit 23 can refer to a history of an aggregate of past topics to determine whether the current topics that are determined in turn are in accordance with the sequential order of the important topics. When the current topic corresponds to an important topic, the control unit 23 transmits information on the corresponding important topic (hereinafter referred to as "corresponding topic") to the terminal device 10. Upon receiving the information on the corresponding topic from the information processing device 20, the control unit 15 of the terminal device 10 shows, on the display, a screen in which an aggregate of non-corresponding topics except for the corresponding topic are given in the form of a list. Alternatively, the control unit 15 can show a screen in which an aggregate of important topics are given in the form of a list, and, for example, gray out the line of the corresponding topic, or put a checkmark at the right end of the line of the corresponding topic, to show the corresponding topic that has already been taken up in the conversation and the non-corresponding topics so as to make a distinction therebetween.

Labels that are set as important topics may be set by the salesperson or a manager who manages this service. The important topics may be different for each terminal device 10, or may be different for each group of the terminal devices 10 as a unit, for example, for each shop. The important topics may be changeable.

In a modified example, the control unit 23 may present the salesperson with an important topic that does not correspond to a past topic, i.e., a non-corresponding topic, among the preset important topics. Specifically, the control unit 23 determines whether the past topic or each of the aggregate of past topics is an important topic. When there is a corresponding topic, the control unit 23 transmits information on the corresponding topic to the terminal device 10, and makes the terminal device 10 show, on the display, the non-corresponding topics except for the corresponding topic so as to make a distinction from the corresponding topic. The control unit 23 may execute this modified example at an arbitrary timing. For example, when a power supply to the terminal device 10 is cut off, or the present service of the terminal device 10 is ended, in a state where it has not been determined in S106 that the conversation has ended, the control unit 23 may execute this modified example upon detecting that the terminal device 10 has started the present service.

In another modified example, each of the important topics is associated with a keyword. The keyword is a word that should be included in the conversation among words having a label set as an important topic attached thereto, and is arbitrarily set. In this case, the words having a label attached thereto may each include information indicating whether it is a keyword. For example, when the conversation between the salesperson and the customer is a business negotiation relating to a sale of a vehicle and the important topic is "payment method," the keywords are "lump-sum purchase," "installment purchase," etc.

When the current topic corresponds to a preset important topic, the control unit 23 may present the salesperson with a keyword that has been associated beforehand with the important topic corresponding to the current topic and that is not included in the conversation. Specifically, when the control unit 23 has extracted a current topic in S101, the control unit 23 determines whether the current topic is an important topic. When the current topic is an important topic, the control unit 23 performs monitoring to see whether a word that is set as a keyword among the words to which the label selected as the current topic is attached is detected from the text data. When a word set as a keyword is detected, the control unit 23 transmits the detected word to the terminal device 10 as information on an already-detected keyword. Upon receiving the information on the already-detected keyword from the information processing device 20, the control unit 15 of the terminal device 10 shows, on the display, a screen in which an aggregate of words that are set as keywords except for the already-detected keyword (hereinafter referred to as undetected keywords) are given in the form of a list. Alternatively, the control unit 15 may show, on the display, a screen in which an aggregate of keywords associated with important topics are given in the form of a list, and, for the part of the keywords, adopt an arbitrary form such that the already-detected keyword can be grasped, such as graying out the line of the already-detected keyword or putting a checkmark at the right end of the line of the already-detected keyword.

In another modified example, each time the current topic changes, the control unit 23 may derive and store emotional states of the salesperson and the customer based on the voice data of a conversation part relating to a past topic. Emotional states

during a conversation include states of emotions such as delight, anger, sorrow, and pleasure, positive and negative feelings, etc. in the conversation. Specifically, in S103, when the control unit 23 has identified the voice data of the conversation part corresponding to the past topic that has been the immediately preceding current topic, for example, the control unit 23 uses the voice data as input data and derives the emotional states of the salesperson and the customer by means of a module for voice feeling recognition etc. that is stored on the cloud or in the storage unit 22 of the information processing device 20. Then, the control unit 23 stores the derived states of the salesperson and the customer in the storage unit 22 or the storage unit 14 of the terminal device 10. In this case, the control unit 23 may also store the summary generated in S104 in the storage unit 22 or the storage unit 14. Thus stored, the emotional states of the salesperson and the customer during the conversation can be used as, for example, teacher data for a learning model using AI. The control unit 23 may detect the emotional states of the salesperson and the customer using not only voice data but also text data and/or image data corresponding to the voice data of the conversation part extracted in S104. When using image data, the image data may be acquired by an imaging unit installed in the terminal device 10, or may be acquired by, for example, a monitoring camera that can image an inside of the shop. Thus performing a multimodal analysis can improve the accuracy in deriving the emotional states of the salesperson and the customer.

In another modified example, the control unit 23 may present the salesperson with a topic that is supposed to be taken up next based on a summary. Specifically, using the summary generated in S104 as input data, the control unit 23 acquires information on the topic that is supposed to be taken up next by means of an LLM, for example. The control unit 23 transmits the topic acquired from the LLM to the terminal device 10 through the communication unit 21 and the network 30. Upon receiving the information on the topic that is supposed to be taken up next from the information processing device 20, the control unit 15 of the terminal device 10 shows, on the display, a screen showing the topic that is supposed to be taken up next. Alternatively, when the label includes information indicating the order of being taken up, the control unit 23 may determine the topic that is supposed to be taken up next based on the information indicating the order of being taken up. For example, it is assumed that the order of being taken up of "description of vehicle model" and "options of services added to vehicle" is in this order, and that the current topic is "description of vehicle model." In this case, the control unit 23 presents the salesperson with "options of services added to vehicle" as the topic that is supposed to be taken up next.

In another modified example, when the current topic corresponds to a preset trend topic, the control unit 23 may present the salesperson with a past summary or a response manual relating to that trend topic. The trend topic is a topic that is highly likely to be taken up by the customer in a conversation between the salesperson and the customer, and is arbitrarily preset. In this case, the label includes information indicating whether the topic is a trend topic. The label set as a trend topic may be associated with a response manual. For example, information on traffic accidents and information on current events, such as gasoline prices, may be set as trend topics. Further, for example, matters asked about by the customer may be set as trend topics. Specifically, when the control unit 23 has extracted a current topic in S101, the control unit 23 determines whether the current topic is a trend topic. When the current topic is a trend topic, the control unit 23 transmits, to the terminal device 10, information on a past summary or a response manual relating to the label corresponding to the current topic. Upon receiving the information on the past summary or the response manual from the information processing device 20, the control unit 15 of the terminal device 10 shows the past summary or the response manual on the display. As the summary relating to a trend topic, a summary for which the states of the salesperson and the customer are stored in the storage unit 22 or the storage unit 14 in accordance with the above-described modified example can be used. Specifically, the control unit 23 searches the storage unit 22 or the storage unit 14 for a past summary of the trend topic. When the search has been done, the control unit 23 determines whether to use the searched-out summary based on the emotional states of the salesperson and the customer associated with the summary. For example, when the emotional states of the salesperson and the customer include a positive response, the control unit 23 determines the summary as the past summary to be presented to the salesperson.

Setting of labels corresponding to trend topics may be performed by the salesperson or the manager who manages this service. The trend topics may be different for each terminal device 10, or may be different for each group of the terminal devices 10 as a unit, for example, for each shop. The trend topics may be changeable.

In another modified example, the control unit 23 may determine that the current topic has changed when the current topic has not changed for a predetermined time

or longer or throughout a predetermined amount (e.g., 3000 letters) or more of text. Specifically, the control unit 23 starts a timer when a conversation between the salesperson and the customer starts or the current topic changes in S102. When the timer reaches a predetermined time, such as ten minutes, or longer, the control unit 23 determines that the current topic has changed. Alternatively, when the current topic has not changed for a predetermined time or longer, the control unit 23 may transmit information prompting end of the current topic to the terminal device 10. Upon receiving the information prompting end of the current topic from the information processing device 20, the control unit 15 of the terminal device 10 shows, on the display, a screen showing the information prompting end of the current topic. The information prompting end of the current topic is information that the control unit 23 presents to prompt the salesperson to change the current topic. One example is a message such as "Change the topic to another one" or "Move on to the subject of vehicle insurance." The accuracy of summarization can be maintained by presenting such information to the salesperson and asking the salesperson to change the topic in the conversation before the probability of a decrease in the accuracy of summarization arises.

Each of the above-described modified examples may be executed by the control unit 15 of the terminal device 10 instead of the control unit 23.

Further, an embodiment is also possible in which, for example, a general-purpose computer functions as the information processing device 20 according to the above-described embodiment. Specifically, a program describing the contents of processing that realize the functions of the information processing device 20 according to the above-described embodiment is stored in a memory of a general-purpose computer, and this program is retrieved and executed by a processor. Thus, the present disclosure can also be realized as a program that can be executed by a processor or as a non-transitory computer-readable medium in which the program is stored.

In the following, some of embodiments of the present disclosure will be illustrated. However, it should be understood that embodiments of the present disclosure are not limited to these.

### Supplement 1

An operation method of an information processing device, including:

acquiring voice data of a conversation between a salesperson and a customer;

using a voice recognition technology, converting the voice data into text data;

using co-occurrence analysis or a topic model, deriving a first topic that is a current topic of the conversation from the text data; and

each time a change of the first topic is detected,

identifying voice data of a conversation part relating to a second topic that is an immediately preceding topic;

generating a summary of the conversation part based on the identified voice data; and

presenting the generated summary to the salesperson.

### Supplement 2

An operation method of an information processing device, including, based on voice data of a conversation between a salesperson and a customer, each time a first topic that is a current topic of the conversation changes, presenting a summary relating to a third topic that is a past topic.

### Supplement 3

The operation method according to Supplement 2, further including, when the first topic corresponds to one of a plurality of preset important topics, presenting the salesperson with important topics other than the important topic corresponding to the first topic.

### Supplement 4

The operation method according to Supplement 2 or 3, further including presenting the salesperson with important topics that do not correspond to the third topic among a plurality of preset important topics.

### Supplement 5

The operation method according to any one of Supplements 2 to 4, further including, when the first topic corresponds to a preset important topic, presenting the salesperson with a keyword that has been associated beforehand with the important topic corresponding to the first topic and that is not included in the conversation.

### Supplement 6

The operation method according to any one of Supplements 2 to 5, further including, each time the first topic changes, deriving and storing emotional states of the salesperson and the customer based on voice data of a conversation part relating to the third topic.

### Supplement 7

The operation method according to Supplement 6, wherein the information processing device is configured to derive and store the emotional states of the salesperson and the customer based further on image data of the conversation.

### Supplement 8

The operation method according to any one of Supplements 2 to 7, further including presenting the salesperson with a topic that is supposed to be taken up next based on the summary.

### Supplement 9

The operation method according to any one of Supplements 2 to 8, further including, when the first topic corresponds to a preset trend topic, presenting the salesperson with a past summary or a response manual relating to the trend topic.

### Supplement 10

The operation method according to any one of Supplements 2 to 9, further including, when the first topic has not changed for a predetermined time or longer, determining that the first topic has changed.

### Supplement 11

An information processing device, including a control unit configured to: acquire voice data of a conversation between a salesperson and a customer; using a voice recognition technology, convert the voice data into text data; using co-occurrence analysis or a topic model, extract a first topic that is a current topic of the conversation from the text data; and each time a change of the first topic is detected, identify voice data of a conversation part relating to a second topic that is an immediately preceding topic; generate a summary of the conversation part based on the identified voice data; and present the generated summary to the salesperson.

An information processing device, including a control unit configured to, based on voice data of a conversation between a salesperson and a customer, each time a first topic that is a current topic of the conversation changes, present a summary relating to a third topic that is a past topic.

### Supplement 13

The information processing device according to Supplement 12, wherein the control unit is configured to, when the first topic corresponds to one of a plurality of preset important topics, present the salesperson with important topics other than the important topic corresponding to the first topic.

### Supplement 14

The information processing device according to Supplement 12 or 13, wherein the control unit is configured to present the salesperson with important topics that do not correspond to the third topic among a plurality of preset important topics.

### Supplement 15

The information processing device according to any one of Supplements 12 to 14, wherein the control unit is configured to, when the first topic corresponds to a preset important topic, present the salesperson with a keyword that has been associated beforehand with the important topic corresponding to the first topic and that is not included in the conversation.

### Supplement 16

The information processing device according to any one of Supplements 12 to 15, wherein the control unit is configured to, each time the first topic changes, derive and store emotional states of the salesperson and the customer based on voice data of a conversation part relating to the third topic.

### Supplement 17

The information processing device according to Supplement 16, wherein the control unit is configured to derive and store the emotional states of the salesperson and the customer based further on image data of the conversation.

### Supplement 18

The information processing device according to any one of Supplements 12 to 17, wherein the control unit is configured to present the salesperson with a topic that is supposed to be taken up next based on the summary.

### Supplement 19

The information processing device according to any one of Supplements 12 to 18, wherein the control unit is configured to, when the first topic corresponds to a preset trend topic, present the salesperson with a past summary or a response manual relating to the trend topic.

### Supplement 20

The information processing device according to any one of Supplements 12 to 19, wherein the control unit is configured to, when the first topic has not changed for a predetermined time or longer, determine that the first topic has changed.

What is claimed is:

1. An operation method of an information processing device, comprising:
acquiring voice data of a conversation between a salesperson and a customer;
using a voice recognition technology, converting the voice data into text data;
using co-occurrence analysis or a topic model, deriving a first topic that is a current topic of the conversation from the text data; and
each time a change of the first topic is detected,
identifying voice data of a conversation part relating to a second topic that is an immediately preceding topic;
generating a summary of the conversation part based on the identified voice data; and
presenting the generated summary to the salesperson.

2. The operation method according to claim 1, comprising, based on the voice data, each time the first topic changes, presenting a summary relating to a third topic that is a past topic.

3. The operation method according to claim 2, further comprising, when the first topic corresponds to one of a plurality of preset important topics, presenting the salesperson with important topics other than the important topic corresponding to the first topic.

4. The operation method according to claim 2, further comprising presenting the salesperson with important topics that do not correspond to the third topic among a plurality of preset important topics.

5. The operation method according to claim 2, further comprising, when the first topic corresponds to a preset important topic, presenting the salesperson with a keyword that has been associated beforehand with the important topic corresponding to the first topic and that is not included in the conversation.

6. The operation method according to claim 2, further comprising, each time the first topic changes, deriving and storing emotional states of the salesperson and the customer based on voice data of a conversation part relating to the third topic.

7. The operation method according to claim 6, wherein the information processing device is configured to derive and store the emotional states of the salesperson and the customer based further on image data of the conversation.

8. The operation method according to claim 2, further comprising presenting the salesperson with a topic that is supposed to be taken up next based on the summary.

9. The operation method according to claim 2, further comprising, when the first topic corresponds to a preset trend topic, presenting the salesperson with a past summary or a response manual relating to the trend topic.

10. The operation method according to claim 2, further comprising, when the first topic has not changed for a predetermined time or longer, determining that the first topic has changed.

11. An information processing device, comprising a control unit configured to:
acquire voice data of a conversation between a salesperson and a customer;
using a voice recognition technology, convert the voice data into text data;
using co-occurrence analysis or a topic model, extract a first topic that is a current topic of the conversation from the text data; and
each time a change of the first topic is detected,
identify voice data of a conversation part relating to a second topic that is an immediately preceding topic;
generate a summary of the conversation part based on the identified voice data; and
present the generated summary to the salesperson.

12. An information processing device, comprising a control unit configured to, based on voice data of a conversation between a salesperson and a customer, each time a first topic that is a current topic of the conversation changes, present a summary relating to a third topic that is a past topic.

13. The information processing device according to claim 12, wherein the control unit is configured to, when the first topic corresponds to one of a plurality of preset important topics, present the salesperson with important topics other than the important topic corresponding to the first topic.

14. The information processing device according to claim 12, wherein the control unit is configured to present the salesperson with important topics that do not correspond to the third topic among a plurality of preset important topics.

15. The information processing device according to claim 12, wherein the control unit is configured to, when the first topic corresponds to a preset important topic, present the salesperson with a keyword that has been associated beforehand with the important topic corresponding to the first topic and that is not included in the conversation.

16. The information processing device according to claim 12, wherein the control unit is configured to, each time the first topic changes, derive and store emotional states of the salesperson and the customer based on voice data of a conversation part relating to the third topic.

17. The information processing device according to claim 16, wherein the control unit is configured to derive and store the emotional states of the salesperson and the customer based further on image data of the conversation.

18. The information processing device according to claim 12, wherein the control unit is configured to present the salesperson with a topic that is supposed to be taken up next based on the summary.

19. The information processing device according to claim 12, wherein the control unit is configured to, when the first topic corresponds to a preset trend topic, present the salesperson with a past summary or a response manual relating to the trend topic.

20. The information processing device according to claim 12, wherein the control unit is configured to, when the first topic has not changed for a predetermined time or longer, determine that the first topic has changed.
